(19) United States
(12) Patent Application Publication
(10) Pub. No.: US 2011/0229604 A1
(43) Pub. Date: Sep. 22, 2011

(54) Momordica Wine

(76) Inventor: Joselito G. Real, (US)

(21) Appl. No.: 13/049,923

(22) Filed: Mar. 17, 2011

Related U.S. Application Data
(60) Provisional application No. 61/315,638, filed on Mar. 19, 2010.

(51) Int. Cl. C12G 1/022; C12G 1/00

(52) U.S. Cl. 426/13; 426/592

(57) ABSTRACT

Plants in the genus Momordica are known for their medicinal values such as those used to treat cancer, HIV, diabetes and other maladies. There are many preparations from Momordica plants that are used for medicinal treatments but the major drawback is the bitterness and palatability of these preparations. A method of extracting these medicinal compounds, specifically those that are water soluble and alcohol soluble have been developed and the resulting product is an alcoholic beverage that has high amounts of medicinal compounds from plants of Momordica genus. The resulting alcoholic beverage is much more pleasant to drink.

### CROSS REFERENCE TO RELATED APPLICATIONS

The present patent application claims priority under 35 U.S.C. $119(e) to U.S. Provisional Patent Application No. 61/315,638 electronically filed on 19 Mar. 2010, the disclosure of which is incorporated herein by reference.

### BACKGROUND OF THE INVENTION

1. Field of the Invention

The present invention relates to a process for the production of Momordica wine from various cultivars and species of plants belonging to the genus Momordica.

2. General Background and State of the Art

Plants in the genus Momordica are cucurbits that are known for their medicinal properties. The Momordica genus belongs to the family Cucurbitaceae in Kingdom Plantae. There are about 83 known species of plants in Genus Momordica as shown in Table 1. These plants are annual or perennial climbers, are herbaceous, or rarely small shrub, natives of tropical and subtropical Africa, Asia and Australia. They are often cultivated as vegetables, with the fruits, stems and leaves prepared in various recipes. Lately, due to the recent scientific and clinical studies, various plant extracts from Momordica plants are prepared and various patents exists for their various methods of extraction and usage, but none have used the art of wine making using Momordica plant parts to extract many of the water-soluble and alcohol soluble bioactive and nutritive components.

There are many species and cultivars belonging to the Momordica genus and the most commonly cultivated and studied species is Momordica charantia. The other popular species included Momordica balsamina, Momordica boivinii, and Momordica cochinchinensis.

Momordica plants are widely grown for their very bitter but edible fruit. They belong to the cucurbit family of vine plants that include melons and gourds. Indians, Africans, Chinese and other Asian cultures grow these popular gourds. The most popular Momordica species is M. charantia and the English names for the plant and its fruit include bitter melon or bitter gourd. Known as ampalaya by the Tagalog and amargozo by other Philippine dialects. South American and Caribbean names include Balsamino, Carilla, and Saraseed. It has also been known simply as Charantia.

The fruits, stems and leaves of Momordica plants are a rich source of vitamin C, Folate (Vitamin B9), Vitamin K, Thiamine, Riboflavin, and other vitamins. They are also a good source of Zinc, Potassium, Iron, other nutrients and excellent source of dietary fiber.

These plants have been used as part of the local pharmacopoeia of Indian, Chinese, and African cultures, dating back several thousand years. It is used as laxative, anthelminthic and abortive. They are also used as a remedy for chronic colitis, bacillary dysentery, catarrh, flux, and cough. They are used to alleviate symptoms of gout, rheumatism and some cases of spleen and liver problems. Momordica plants, especially those of M. charantia are also helpful to people with sluggish digestion, dyspepsia, and constipation. Recently, their anti-diabetic properties have been confirmed in many animal and human clinical trials. Some of the most modern hospitals in India often dispense bitter melon supplements to help control diabetes. The leaves of the plants when used as tea have been confirmed to control malaria in laboratory tests. The plant extracts have also been proven to reduce visceral obesity or help fight obesity by reducing unwanted fats.

Eating M. charantia fruits or taking concentrated extracts is especially good in boosting the immunities of people that have cancer or those that are infected with HIV/AIDS. Extracts from the plants are showing that it has immunomodulator properties, which means that it boosts immune cell function in people with cancer and HIV infections.

Many studies from the world over proves that bitter melon help prevent or counteract type-II diabetes. The Philippine Department of Health issued a circular stating that bitter melon, as a scientifically validated herbal medicinal plant, can lower elevated blood sugar levels. The study revealed that a 100 milligram per kilo dose per day is comparable to 2.5 milligrams of the anti-diabetes drug Glibenclamide taken twice per day.

Recent studies have shown that M. charantia contains four very promising compounds that activate a protein called AMPK (5′ adenosine monophosphate-activated protein kinase), an enzyme that plays a role in controlling cellular energy balance and facilitating glucose uptake, which are malfunctioning in diabetic persons. Bitter melon also contains a type of lectin that has insulin-like property. The lectin's insulin-like bioactivity is due to its linking together 2 insulin receptors. This lectin lowers blood glucose concentrations by acting on peripheral tissues and, similar to insulin's effects in the brain, suppressed appetite. The lectin is likely a major contributor to the hypoglycemic effect that develops after eating bitter melon and why it may be a way of managing adult-onset diabetes. Lectin binding is non-protein specific, and this is likely why bitter melon has been credited with immunostimulatory activity—by linking receptors that modulate the immune system, thereby stimulating said receptors.

Other known compounds in the Momordica plants include Momordicins in the form of Momordicosides A, B, Q, R, S and T, that are pinpointed to be boosting the immunities of people against cancer and HIV/Aids, Cucurbitane Triterpenoids, Cucurbitane glycosides, Porphyrins (mainly responsible for anti-diabetic properties), Vincine, Mycose, Karaviloside, Momorcharin and Charantin.

Perhaps, the biggest drawback to the Western World's usage of Momordica plants is the bitterness imparted from the plant parts, especially the various cooking recipes and herbal tea preparations. This invention aims to attenuate the bitterness of the plant extracts, maximize the extraction of water-soluble and alcohol soluble components of the Momordica plant parts which can be done using wine making method where the plant materials are fruits, stems, tendrils and leaves or any combination thereof, of plants belonging to Momordica genus. In the several past trials done by the inventor Joselito Real, he found that wine yeasts lasted longer and will often bring the wine to dryness, completing fermentation. It is very important to note that consuming plants in the Momordica genus has no negative effects on normal people that are non-diabetic so that it can be enjoyed by a wide diversity of people.

Capturing the medicinal essences while attenuating the bitterness of the charantia fruits is the main reason why this unique wine making process was invented to produce Momordica wine. The careful wine making process allowed for longer steeping methods for maximum extraction of all water soluble and alcohol soluble medicinal compounds from Momordica plant parts. To further attenuate the imparted bitterness and improve the wine flavor, cinnamon is optionally added at the end of fermentation process. Cinnamon in itself is known for its medicinal properties that alleviate diabetic symptoms. This would further boost the anti-diabetic properties of the wine and improve its flavor. Cinnamon is also a good wine preservative, and when used correctly will help clarify the wine. The addition of cinnamon will stop fermentation of the yeast and stabilize the wine from microbial contamination, foregoing the need to use harsh chemical preservatives such as sulfites and sorbates.

There is a need in the art to make beverages that are more delightful to drink and yet imparts the nutritional and health benefits derived from plants belonging to the genus Momordica.

### SUMMARY OF THE INVENTION

In one aspect of the invention, the alcoholic beverage or wine making process of the invention involves three or more of the following procedures:

(a) Selecting fresh, disease-free above-ground plant parts from various Momordica plant species and cultivars (above-ground plant parts referred to are fruits, stems, flowers, tendrils and leaves, singly or in various combinations); cleaning and surface sterilization of harvested Momordica plant parts;

(b) dipping into acidic solution or spraying with acidic solution;

(c) crushing, macerating, slicing, grinding, juicing, comminuting of Momordica plant parts and collecting into sterilized primary fermenter;

(d) combining with pectic enzyme, amylase, acids, warm water into the same sterilized primary fermenter;

(e) maintaining optimum temperature and allowing the mixture to stand for 0.25-72 hours;

(f) adding sugars to the mixture;

(g) adding yeast or yeast culture and yeast nutrient to the mixture;

(h) aeration and stirring to add oxygen, maintain temperature and submerging the Momordica plant parts for longer steeping and better extraction;

(i) straining of the wine and collecting into sterilized secondary fermenter for anaerobic fermentation when the specific gravity reading dips below 1.025;

(j) racking off lees of the wine into a sterile container and optional addition of cinnamon to stop the yeast from fermentation, stabilize and preserve the wine;

(k) racking off the cinnamon sediments into sterilized containers, optional addition of fining agents;

(l) conditioning the wine with sweeteners, glycerine and other optional spices; aging the wine;

(m) optional filtering and bottling;

In this aspect of wine making process, the Momordica plant parts to be used are composed of above-ground plant parts such as fruits, stems, tendrils, leaves, flowers or various combinations of plant parts and of cultivars or species of plants in the Momordica genus such as Momordica charantia, Momordica bovinii, Momordica balsamina, and other Momordica spp.

In step (a), healthy and disease-free Momordica plant parts are selected and weighed for processing. The Momordica plant parts that will be used in the wine making process is about 0.10 kg to 2.05 kg fresh weight of Momordica plant parts per 750 ml bottle of final wine produced.

In step (b), the acidic solution is comprised of tart citrus juices such as those from lemons, limes, calamondins, limequats, lemonquats, yuzu, yuzuquat, sudachi, their various hybrids, and their juice combinations, and citric acid, malic acid, tartaric acid and ascorbic acid, in various combinations.

In step (c), the intent is to comminute the Momordica plant parts, using knives, gadgets or machines for crushing, macerating, slicing, grinding, juicing, pressing, or comminuting of Momordica plant parts to break down the Momordica plant parts into smaller pieces. A small amount of sterilized water may be minimally used to aid in this process, such as those in grinding using blenders, but the water should be measured and not to exceed 1 liter per kg of Momordica plant parts in this step.

In step (d), warm sterilized water, preferably non-chlorinated water a are added at the rate of between 0.10 liter to 8.0 liters per kg of Momordica plant parts depending on the amount of water used in step (c) and the desired final Momordica wine formulation. Pectic enzymes, amylase enzymes and an optional combination with amyloglucosidase enzymes are added.

In step (e), the resulting comminuted Momordica plant parts prepared in step (d) are then tightly air sealed, and set aside, from 0.25 to 72 hours curing period, for enzymatic reactions to occur at optimum temperature. The mixture is heated or cooled to maintain the optimum temperature range at the desired time duration depending on quality of the Momordica plant parts. Optionally, before the mixture is sealed for enzymatic reaction, sulfites in the form of Campden tablets or potassium metabisulfite or sodium metabisulfite are added at the rate of between 10 milligram to 1.5 grams per liter of mixture to sterilize the mixture against unwanted microorganisms and to prevent oxidation during the enzymatic reactions.

In step (f), fermentable sugars are added to the mixture and stirred while the mixture is still warm. The amount of sugar added is between 0.15 kg to 0.65 kg per liter of mixture. Inverted sugars are strongly recommended as they impart natural fruit sweetness. But other sugars such as sucrose from sugarcane or beet, corn sugar, fructose, glucose, brown sugar, coconut palm sugar can be used, as well as syrupy substances such as maple syrup or honey. The final brix reading should be between 13 deg brix to 35 deg brix, producing a final wine with 7% to 21% ABV. The Brix reading is adjusted higher by adding more sugar sources or adjusting lower by adding water or making more Momordica mixture prepared up to step (e). The mixture is then cooled down by removing any applied heat, letting cool by ambient environment or by mechanical means the primary fermenter so that the mixture reaches a temperature range of 27-32 deg C.

Steps (d) and (f) can be optionally combined in one step, by adding the sugars in step (d) and proceeding to step (e) and then to step (g).

In step (g), yeast culture from the previous primary fermenter is preferably used and added to the mixture in the primary fermenter when temperature first reaches the range of 27-32 deg C. Optionally a brand new batch of yeast culture can be started or active dry yeast from commercially available packets can be used as directed. The yeast nutrients are also added along, and the yeast nutrients that can be used are composed of various mixtures of one of the following commercially available food-grade ingredients: diammonium phosphate, Nutravit, Fermaid, ammonium sulfate, yeast hulls, Yeastex, and yeast energizer. Optionally, bentonite can be added at this stage to provide settling sites for yeast and to help clear out positively charged haze substances in the wine when fermentation has stopped.

In step (h), after at least 8 hours and for each day thereafter the yeast and yeast nutrients are added, the mixture is stirred twice each day to add oxygen, to cool off the solution, to evaporate the sulfites if added, and to submerge the comminuted Momordica plant parts for better extraction of medicinal compounds in Momordica plant parts. The specific gravity is checked each day and the stirring is stopped until the specific gravity dips below 1.025.

In step (i) after the specific gravity dips below 1.025, the mixture is strained and collected into sterilized secondary fermenter. The residues from the straining process are pressed to extract the remaining juices and are combined into the same secondary fermenter. At this stage, additional sugars and yeast nutrient may be added to boost the alcohol content and the sweetness of the final wine. The secondary fermenter is sealed with an airlock or one way air valve, to let gasses out but not into the fermenter. This fermentation step is completely anaerobic and could continue for two to six weeks depending on ambient temperature and the total sugars added.

In step (j) when the bubbling in the air locks has stopped, or when the desired specific gravity is reached, or when there are no more significant changes in the Specific gravity over a two to three day period, the wine is racked off from the lees into a sterile container. To insure complete stopping of fermentation, cinnamon, in the form of stick or specially prepared powder is optionally added, to also mask the bitterness of the wine, improve its taste, impart anti-diabetic medicinal properties of cinnamon into the wine solution, and to stabilize and preserve the wine. If the powder form of cinnamon is used, it is prepared as cinnamon mixture, added to boiling water at the rate of 1 gram to 250 grams per liter of boiled purified water boiled between 1 to 45 minutes to produce a cinnamon infused hot water mixture. This cinnamon infused mixture is added to the racked wine at the rate of 0.1 to 20 liters hot cinnamon mixture per 200 liters of wine.

In step (k), if optional addition of specially prepared cinnamon in powder form is used, the wine is racked off after 4 to 36 hours, from the cinnamon sediments, into sterilized aging containers. Fining agents may optionally be added at this stage if the wine is cloudy. Example of fining agents include mineral clays such as bentonite; protein based such as gelatin, isinglass, casein, blood and albumen; polysaccharide types such as agar and chitosan; Carbon types such as charcoal and activated carbon; synthetic polymers such as PVPP; silicon types such as Silicon dioxide or kieselsol; and others, including chelators such as Sparkolloid and enzymes such as pectinases and amylases. If bentonite was used in step (g), then Chitosan or gelatin can be used as a follow-up fining agent at this step.

In step (l), after the desired aging of 2 to 52 weeks depending on type of flavor and wine style, the wines are racked off from various batches and collected into a single container for uniformity of the batch vintage. Conditioning of the wine may involve optional addition of food grade glycerine, inverted sugar, maple syrup, honey, natural sweeteners such as Stevia, artificial sweeteners such as aspartame, and other optional spices. The conditioned wine is then allowed to sit for 2 to 72 hours.

In step (m), after the wines are conditioned and let stand, they are optionally filtered and bottled into sterilized bottles of various sizes. The bottles are to be kept standing upright for one to five days before they are set on their side for at least one week before they are shipped off or aged further in wine cellars.

In another embodiment, the invention is directed to the wine from plants belonging to the Momordica genus, produced by any combinations of the above methods.

### DETAILED DESCRIPTION OF THE INVENTION

As used herein, “Momordica plants” refer to all the species and cultivars of plants belonging to the Momordica genus of family Cucurbitaceae in Kingdom Plantae. There are about 83 known species of plants in Genus Momordica as shown in Table 1. These plants are annual or perennial climbers, are herbaceous, or rarely small shrub, natives of tropical and subtropical Africa, Asia and Australia.

As used herein, “Momordica plant parts” refer to any of the above-ground parts of the plants that include fruits, stems, leaves, flowers and tendrils, in any combination of parts, and of any combination of the listed 83 species of plants in the Momordica genus (Table 1).

As used herein, “fining agent” refers to substance or substances added to the wine or liquid mixture in process of turning into wine. The fining agent can react chemically with undesirable substances in the wine or can adsorb the undesirable substances in the wine with the primary purpose of achieving clarity, improving color, improving flavor and improve chemical and physical stability of the wine Fining agents can include any combinations of 1) Protein types such as isinglass, gelatin, casein, albumen, animal blood; 2) Mined types such as Bentonite, montmorillonite, diatomaceous earth and other mined clays; 3) Polysaccharide types such as agars and chitosan; 4) Carbons such as charcoal and activated charcoal; 5) Enzymes such as Pectinases Amylases and Amyloglucosidases; 6) Blends such as Sparkolloid; 7) Synthetics such as Silicon Dioxide (Kieselsol) and PVPP; 8) Chelators; and 9) Other miscellaneous types such as Irish moss.

As used herein, “must” refers to the mixture that will be fermented and turned into wine. The mixture in this context is composed of comminuted Momordica plant parts, acids, enzymes, water, and other ingredients.

As used herein, “lees” refers to the solid particles that settle at the bottom of wines during fermentation and aging.

As used herein, “primary fermenter” refers to the first container used for fermentation. It has removable lid to allow mechanical stirring and pouring of the fermented wine.

As used herein, “secondary fermenter” refers to the next container used for anaerobic fermentation. It is sealed air tight, with one way valves or air locks to allow gasses to escape from the fermenter and not allow any gasses back in.

As used herein, “stabilizers” refer to one or more combinations of wine additives that are added to the wine to eliminate or minimize the risk of wine oxidation, microbial spoilage, refermentation, and to maintain homogeneity, clarity and color stability throughout the aging process or storage.

In the present application, “a” and “an” are used to refer to both single and a plurality of objects.

The following example of Momordica Wines recipes are offered by way of illustrations and not by way of limitations:

Exemplified ingredients of Momordica Wine (for 55-gallon/208-liter barrel of wine)

Fresh Momordica charantia fruits: 28-570 Kg.

Water (sterilized, non-chlorinated): 15-175 liters.

Sugars: 31-100 Kg.

Wine yeasts: 0.5-10.0 liters of yeast sediments from previous batch or 15-150 g of active dry wine yeasts, or liquid yeast culture.

Acid dipping solution: 0.25-15.0 grams of acids/liter sterilized water. Acids are a blend of citric, malic, tartaric and ascorbic acid powders. Optionally add juices from lemons, limes, calamondins, limequats, lemonquats, yuzu, sudachi, and their various combinations.

Pectic Enzymes: 10-750 grams

Amylase Enzymes: 0-300 grams

Amyloglucosidase Enzymes (optional): 0-250 grams

Yeast Nutrient Nutravit or Fermaid 10-800 grams.

Sulfur Dioxide (optional): 0-200 ppm

Cinnamon (Optional): 0-750 grams

Bentonite fining agent (optional): 0-55 grams

Chitosan Fining agent (optional): 0-950 grams

Stabilizers (Optional): Potassium sorbate (0-300 ppm), sulfur dioxide (0-150 ppm)

Glycerine (Optional): 0-1,250 grams

Sweetener, Stevia (Optional): 0-250 grams

### Process of Winemaking

The Momordica winemaking process is described below, however, it is understood that a variation in the order of the steps is contemplated within the scope of the invention so long as Momordica wine is made. Further, the process exemplified here is for making a barrel of wine, 55-gallon volume or 208 liter volume of wine, which can be scaled up or down as desired.

Momordica plant parts are harvested. Only disease-free plant parts are used. The Momordica plant parts are then weighed for the desired recipe and are then washed with clean water. Then the Momordica plant parts are rinsed with sterile water. Optionally, the plant parts can be rinsed with ozone treated water if non-sulfited wines are desired or to reduce further microbial contamination. Scientific studies have shown that rinsing of fruits and vegetables in ozone treated water dramatically extends shelf life and their freshness. The ozone simply reverts back to oxygen during the process without producing any undesirable by-products. This is important to preserve the freshness of Momordica plant parts, eliminate bacterial contamination, and avoid the use of chlorinated water and other harsh sterilizing chemicals such as sulfites.

After the washing and surface sterilization, the Momordica plant parts are then dipped in acidic solution prepared by mixing together acids such as citric, malic, tartaric and ascorbic acid powders. Optionally lemon juice is added. Other citrus juices can be used such as those from limes, calamondins, limequats, lemonquats, yuzu, sudachi, and their various combinations.

After the plant parts are dipped in the solution, they are immediately sliced, minced or grounded and collected into a sterilized primary fermenter. The plant parts are immediately processed with the acids still adhering to its surfaces in order to minimize or prevent browning and help extract acid soluble compounds from Momordica plant parts during the processing. Another alternative is to spray the acidic solution into the plant parts while they are being comminuted.

Water at 26 deg C. to 70 deg C. is then added into the primary fermenter. The idea here is to mix water at particular temperature together with the comminuted Momordica plant parts so that the final temperature of the mixture is between 27-52 deg C., with the optimum temperature at 45 deg C. to achieve the fastest enzymatic reaction rates in the next step. The addition of water changes the pH towards neutrality, so mixture is then checked for pH, and the acidic dipping solution prepared in the first step is added so that the final pH of the mixture is in the range of 2.00 to 5.00. If the acidic dipping solution is not enough to bring the pH down to this range, more acid powders composed of citric, malic, tartaric and ascorbic acid are incrementally added. If we forego the addition of sulfites later in the process, more ascorbic acid is added to compensate for oxidation.

The enzymes pectinases, amylases and amyloglucosidases are then added to the mixture and stirred. Sulfites are optionally added to help maintain a sterile mixture. The primary fermenter is then covered air tight to let the enzymatic reactions proceed for a period of 0.25 to 72 hours, depending on amount of enzymes used and quality of plant materials, maintained at temperature of 27 to 52 deg C. with 45 deg C. as being the optimum. During this step, the pectinases will break down the pectins and the cell walls of the Momordica plant parts, releasing more bioactive compounds, and various water soluble medicinal compounds and nutrients. Amylases and amyloglucosidases will break down complex carbohydrates and starches of the Momordica plant parts and turn them into sugars.

After the enzymatic reaction step, sugars are added, and stirred into the solution. In particular, fermentable sugars such as sucrose, glucose, and fructose are highly recommended because they can be fermented easily by wine yeasts. Optionally, to achieve faster fermentation, inverted sugar can also be used. table sugar or sucrose can also be inverted using acid hydrolysis technique by mixing sugar with water and citric acid or acidic citrus juice, and heating the mixture and maintaining it at a temperature of 88 deg C. for at least 30 minutes. Other sugars or blends that have high fermentable sugars as indicated earlier, can be used. After adding sugar, the mixture is then stirred to dissolve the sugar. The brix reading is then measured. In the embodiment of the invention, the final brix reading should be between 13 deg brix to 35 deg brix depending on the percentage Alcohol By Volume (ABV) desired. A 13 deg Brix makes wine with approximate ABV of 7% and a 35 deg Brix will produce a wine of 21% ABV. If the brix reading is higher than 35 deg brix, water is added and if it is lower than 13 deg brix, sugar is added. Sugars are always added stepwise, in increments of 1 percent by estimated weight of total mixture. Optionally, a computer software developed by Joselito G. Real is used to calculate the exact amount of water or sugar to add in just one step, and the amount is calculated based on the initial volume, initial brix reading and the desired brix reading of the mixture. Optionally, the total amount of sugars can be split into several applications, with ½ to ¾ during the sugar addition and the rest, ½ to ¼ are added at strategic times before the fermentation is completed. This is to minimize incidence of stuck fermentation in case the wine yeast strain used cannot tolerate high sugar concentrations. This will help wine yeast ferment all the sugars added to dryness.

The addition of sugar can be optionally done simultaneously with the addition of enzymes. In general, if the complex carbohydrate content of the mixture is high, the enzymatic reaction step should be done first in order to let the reactions go further and faster because some of the end products of enzymatic reactions are sugar. And without sugars during the enzymatic reaction phase, the reaction goes forward readily at a faster rate. But if complex carbohydrates content are lower, sugars can be combined together with the enzymes. The duration of enzymatic reactions or the simultaneous addition of sugars and enzymes depend on the quality of the Momordica plant parts used.

The mixture is allowed to cool down by removing any heat if applied, or simply letting it cool in the cooler ambient air, or by using any cooling mechanism to bring temperature of the mixture in the 27-32 deg C. range, which is ideal for wine yeast inoculation.

Wine yeast from the previous batch of Momordica wine is preferably used because the yeast is already acclimated to the Momordica plant parts and their extracts. If this is the first batch, wine yeast culture can be prepared and added according to manufacturer's instructions. The primary fermenter is then covered with non-airtight lid or screen so that it can be protected against insects, dust and other dirt and can be easily opened for mechanical stirring. The temperature of the mixture is kept in the range of wine yeast's active operating temperature, mostly between 15-30 deg C.

Over the course of several days, after at least 8 hours, the mixture is stirred at least twice each day to knock down or punch down, mix and submerge the floating Momordica plant parts that float on the surface during the active fermentation for improved extraction efficiency, to release some heat produced during vigorous fermentation and to provide oxygenation for the actively growing population of yeasts.

Everyday, the specific gravity (SG) is measured using hydrometer. If the sugar application is split applied, it is best to add additional sugars whenever specific gravity falls to 1.035 and below. Sugar can be added at different SG level as long as they are below the tolerance levels of the yeast.

When the specific gravity reading falls below 1.025, the mixture in the primary fermenter is then poured onto a strainer and the juices collected into a sterilized secondary fermenter. The residue in the strainer is then pressed and the remaining juices mixed into the same secondary fermenter. The content of the secondary fermenter is then topped off so that the liquid contents would be 2-10 cm from the topmost portion of the fermenter. Liquid used for topping off includes sterilized water, or sugar solution that has the same brix as the original mixture before fermentation, previous batches of wine, or topped off with Momordica juice extracts or any combination thereof. The secondary fermenter is then sealed with a fermentation lock (also known as an air lock) or one way gas valves that lets fermentation gasses out of the fermenter but not let the air inside. The fermentation inside the secondary fermenter is completely anaerobic and can take anywhere from 5-45 days depending on the quality of the wine. If malolactic acid fermentation has occurred, it would take additional 2 months for the process to complete. The wine is kept at a temperature between 15-30 deg C. during this period.

The specific gravity reading is taken daily and kept track of. When the reading has stabilized for a period of one week, or when there is no more outgassing, or when the specific gravity reading has fallen below 1.000, the wine is carefully racked, leaving off the sediments, into another sterilized container. The sterilized container is then topped off in the same way leaving only an air gap of 2-10 cm on top of the container. Topping liquid would be sterilized water, or sugar solution that has the same brix as the original mixture or previous batches of wine, or any combination thereof.

If cinnamon powder is optionally used to add cinnamon flavor and impart medicinal compounds from cinnamon, or to stop further fermentation, or help clarify the wine, it is first prepared by adding the cinnamon powder into boiling water at the rate of 1-250 grams per liter. The cinnamon mixture is boiled further between 1 to 45 minutes to produce a cinnamon infused hot water mixture. The hot mixture is then added to the racked wine at the rate of 0.1 to 20 liter cinnamon mixture per 200 liters of wine. The wine is then stirred thoroughly to mix the cinnamon. The container is then sealed with an air lock and let stand for 8 to 36 hours to let the cinnamon settle out. The wine is then carefully racked off into another sterilized container and topped off in the same way as the previous container.

The wines are racked off every month or two, repeated as many times until it can't be cleared any further after a period of 3 to 12 months.

At the last racking, the wine is then degassed to remove dissolved carbon dioxide, using vacuum degasser or mechanical stirrers, or by subjecting the wine into warm temperature, 30-38 deg C., for a period of 1-3 days or any combination.

The wines could be optionally clarified using appropriate clarifying agents depending on the previous clarifying agents used, the turbidity of the wine or the analysis of the wine particles. If bentonite or other negatively charged fining agent was used earlier then chitosan or other positively charged fining agents are used as a follow-up fining agent Fining agents can include any combinations of 1) Protein types such as isinglass, gelatin, casein, albumen, animal blood; 2) Mined types such as Bentonite, montmorillionite, diatomaceous earth and other mined clays; 3) Polysaccharide types such as agars and chitosan; 4) Carbons such as charcoal and activated charcoal; 5) Enzymes such as Pectinases Amylases and Amyloglucosidases; 6) Blends such as Sparkolloid; 7) Synthetics such as Silicon Dioxide (Kieselsol) and PVPP; 8) Chelators; and 9) other miscellaneous types such as Irish moss. After adding fining agent(s), the wine is then set aside for sedimentation according to type of fining agent(s) used.

The wine is then racked off into another sterilized container after the fining agents have settled at the bottom. The wine at this stage can be conditioned to taste and style, by adding a solution of inverted sugar, glycerine, spices or any combinations thereof.

The wine is then stabilized by optionally adding potassium sorbate in conjunction with sulfites, or using a filtration process that removes microbial and yeast cells. The stabilized wines are then stored and aged or cellared in a dark and cool place for a period of one month to two years.

The wine is then bottled after the aging process. The bottles are first kept upright for a period of 1 to 5 days after bottling, and then they are aged further horizontally for a period of one week to one month in the cellar. They are then placed for further storage, distributed for sales or consumption.

It is not the intention of the present invention, described herein, to be limited in scope, or otherwise, to the specifics reported. Instead, various modifications are indeed sure to become apparent to those who are skilled in interpreting the accompanying description and figures provided. These modifications are both encouraged and welcomed to the originally provided invention. Those aforementioned skilled individuals will be able to both recognize and/or ascertain many equivalents to the specific embodiments of the invention specifically described herein. The subsequently developed embodiments are intended to be encompassed within the scope of such claims.

TABLE 1
Sample listing of plant species belonging to the Momordica genus.

| Number | Species Name | Taxonomist/Cultivar |
|---|---|---|
| 1 | Momordica aculeata | (Poir.) |
| 2 | Momordica acuminata | (Merr.) |
| 3 | Momordica affinis | (De Wild.) |
| 4 | Momordica amaniana | (Cogn.) |
| 5 | Momordica angolensis | (R. Fernandes) |
| 6 | Momordica angustisepala | (Harms) |
| 7 | Momordica anigosantha | (Hook. f.) |
| 8 | Momordica auriculata | (Noronha) |
| 9 | Momordica balsamina | (L.) |
| 10 | Momordica bequaertii | (De Wild.) |
| 11 | Momordica boivinii | (Baill.) |
| 12 | Momordica bracteata | (Hutch & Dalziel) |
| 13 | Momordica bricchettii | (Chiov.) |
| 14 | Momordica cabrae | ((Cogn.) C. Jeffrey) |
| 15 | Momordica calantha | (Gilg) |
| 16 | Momordica camerounensis | (Keraudren) |
| 17 | Momordica chinensis | (Hort.) |
| 18 | Momordica clematidea | (Sond.) |
| 19 | Momordica charantia | (L. - Bitter melon) |
| 20 | Momordica cissoides | (Planch. ex Benth.) |
| 21 | Momordica clarkeana | (King) |
| 22 | Momordica cochinchinensis | ((Lour.) Spreng. - Gac) |
| 23 | Momordica cogniauxiana | (De Wild.) |
| 24 | Momordica cordata | (Cogn.) |
| 25 | Momordica coriacea | (Cogn.) |
| 26 | Momordica corymbifera | (Hook. f.) |
| 27 | Momordica cymbalaria | (Hook. f.) |
| 28 | Momordica denticulata | (Miq.) |
| 29 | Momordica denudata | (C. B. Clarke) |
| 30 | Momordica dictyosperma | (Griseb) |
| 31 | Momordica dioica Roxb. | (ex Willd.) |
| 32 | Momordica diplotrimera | (Harms) |
| 33 | Momordica dissecta | (Baker) |
| 34 | Momordica eberhardtii | (Gagnep.) |
| 35 | Momordica enneaphylla | (Cogn.) |
| 36 | Momordica fasciculata | (Cogn.) |
| 37 | Momordica foetida | (Schumach.) |
| 38 | Momordica gabonii | (Cogn.) |
| 39 | Momordica glabra | (Zimmerman) |
| 40 | Momordica gracilis | (De Wild. & T. Durand) |
| 41 | Momordica grandibracteata | (Gilg) |
| 42 | Momordica henriquesii | (Cogn.) |
| 43 | Momordica involucrata | (E. Mey.) |
| 44 | Momordica jeffreyana | (Keraudren) |
| 45 | Momordica laotica | (Gagnep.) |
| 46 | Momordica laurentii | (De Wild.) |
| 47 | Momordica leiocarpa | (Gilg) |
| 48 | Momordica littorea | (Thulin) |
| 49 | Momordica macrantha | (Gilg) |
| 50 | Momordica macrophylla | (Gage) |
| 51 | Momordica mannii | (Hook. f.) |
| 52 | Momordica marlothi | (Harms) |
| 53 | Momordica martinicensis | (Hook. ex Wien.) |
| 54 | Momordica meloniflora | (Hand.-Mazz.) |
| 55 | Momordica microphylla | (Chiov.) |
| 56 | Momordica mossambica | (H. Schaef.) |
| 57 | Momordica multicrenulata | (Cogn.) |
| 58 | Momordica multiflora | (Hook. f.) |
| 59 | Momordica obtusisepala | (Keraudren) |
| 60 | Momordica parvifolia | (Cogn.) |
| 61 | Momordica pauciflora | (Cogn. ex Harms) |
| 62 | Momordica pedisecta | (Ser.) |
| 63 | Momordica peteri | (A. Zimm.) |
| 64 | Momordica pterocarpa | (Hochst.) |
| 65 | Momordica pycnantha | (Harms) |
| 66 | Momordica racemiflora | (Cogn.) |
| 67 | Momordica repens | (Bremek.) |
| 68 | Momordica rostrata | (A. Zimm.) |
| 69 | Momordica rumphii | (W. J. De Wilde) |
| 70 | Momordica runssorica | (Gilg) |
| 71 | Momordica rutshuruensis | (De Wild.) |
| 72 | Momordica sahyadrica | (Kattuk. & V. T. Antony) |
| 73 | Momordica schinzii | (Cogn. ex Schinz) |
| 74 | Momordica schliebenii | (Harms) |
| 75 | Momordica sessilifolia | (Cogn.) |
| 76 | Momordica silvatica | (Jongkind) |
| 77 | Momordica somalensis | (Chiov.) |
| 78 | Momordica suringarii | (Cogn.) |
| 79 | Momordica thollonii | (Cogn.) |
| 80 | Momordica tonkinensis | (Gagnep.) |
| 81 | Momordica trifoliolata | (Hook. f.) |
| 82 | Momordica welwitschii | (Hook. f.) |
| 83 | Momordica wildemaniana | (Cogn.) |

### OTHER REFERENCES

1. A histological study of the structural changes in the liver of streptozotocin-induced diabetic rats treated with or without Momordica charantia (bitter gourd). Teoh S L, Latiff A A, Das S. Clin Ter. 2009 July-August; 160(4):283-6.
2. An experimental evaluation of the antidiabetic and antilipidemic properties of a standardized Momordica charantia fruit extract. Fernandes N P, Lagishetty C V, Panda V S, Naik S R. BMC Complementary and Alternative Medicine 2007, 7:29
3. Anti-diabetic and hypoglycaemic effects of Momordica charantia (bitter melon): a mini review. Leung L, Birtwhistle R, Kotecha J, Hannah S, Cuthbertson S. Br J. Nutr. 2009 December; 102(12):1703-8.
4. Antihyperglycemic, antihyperlipidemic and antioxidant effects of Dihar, a polyherbal ayurvedic formulation in streptozotocin induced diabetic rats. Patel S S, Shah R S, Goyal R K. Indian J Exp Biol. 2009 July; 47(7):564-70.
5. Anti-tumor activity and immunological modification of ribosome-inactivating protein (RIP) from Momordica charantia by covalent attachment of polyethylene glycol. Li M, Chen Y, Liu Z, Shen F, Bian X, Meng Y. Acta Biochim Biophys Sin(Shanghai). 2009 September; 41(9):792-9.
6. Bitter gourd suppresses lipopolysaccharide-induced inflammatory responses. Kobori M, et. al. National Food Research Institute, Tsukuba, Ibaraki 305-8642, Japan.
7. Bitter melon protects against lipid peroxidation caused by immobilization stress in albino rats. Chaturvedi P. Int J Vitam Nutr Res. 2009 January; 79(1):48-56.
8. Complementary and Comparative Study on Hypoglycemic and Antihyperglycemic Activity of Various

Extracts of Eugenia jambolana Seed, Momordica charantia Fruits, Gymnema sylvestre, and Trigonella foenum graecum Seeds in Rats. Yadav M, Lavania A, Tomar R, Prasad G B, Jain S, Yadav H. Appl Biochem Biotechnol. 2009 Nov. 11.
9. Differential scanning calorimetric and spectroscopic studies on the unfolding of Momordica charantia lectin. Similar modes of thermal and chemical denaturation. Kavitha M, Bobbili K B, Swamy M J. Biochimie. 2009 Sep. 22.
10. Effect of Momordica charantia L. in the resistance to aminoglycosides in methicilin-resistant

Staphylococcus aureus. Coutinho H D, Costa J G, Falcão-Silva V S, Siqueira-Júnior J P, Lima E O. Comp Immunol Microbiol Infect Dis. 2009 Sep. 2.
11. Effects of Momordica charantia on insulin resistance and visceral obesity in mice on high-fat diet. Shih C C, Lin C H, Lin W L. Diabetes Res Clin Pract. 2008 August; 81(2):134-43. Epub 2008 Jun. 11.
12. Eleostearic Acid inhibits breast cancer proliferation by means of an oxidation-dependent mechanism. Grossmann M E, Mizuno N K, Dammen M L, Schuster T, Ray A, Cleary M P. Cancer Prey Res (Phila Pa.). 2009 October; 2(10):879-86.
13. Enzymatic properties of a recombinant phospholipid hydroperoxide glutathione peroxidase from Momordica charantia and its complementation function in yeast. Dong C J, Yang X D, Liu J Y. Biochemistry (Mosc). 2009 May; 74(5):502-8.
14. Fruit extracts of Momordica charantia potentiate glucose uptake and up-regulate Glut-4, PPAR gamma and PI3K. Kumar R, Balaji S, Uma T S, Sehgal P K. J. Ethnopharmacol. 2009 Dec. 10; 126(3):533-7. Epub 2009 Sep. 8.
15. Mass attenuation coefficients of X-rays in different medicinal plants. Morabad R B, Kerur B R. Appl Radiat Isot. 2009 Oct. 24.
16. No effect of acute, single dose oral administration of Momordica charantia Linn., on glycemia, energy expenditure and appetite: a pilot study in non-diabetic overweight men. Kasbia G S, Amason J T, Imbeault P. J. Ethnopharmacol. 2009 Oct. 29; 126(1):127-33.
17. Ribosome inactivating proteins (RIPs) from Momordica charantia for anti viral therapy. Puri M, Kaur I, Kanwar R K, Gupta R C, Chauhan A, Kanwar J R. Curr Mol Med. 2009 December; 9(9):1080-94.
18. Role of Momordica charantia in maintaining the normal levels of lipids and glucose in diabetic rats fed a high-fat and low-carbohydrate diet. Chaturvedi P. Br J Biomed Sci. 2005; 62(3):124-6.
19. GRIN. “Species in GRIN for genus Momordica”. Taxonomy for Plants. National Germplasm Resources Laboratory, Beltsville, Md.: USDA, ARS, National Genetic Resources Program. http://www.ars-grin.gov/cgi-bin/npgs/html/splist.pl?7719. Retrieved Oct. 22, 2009.
20. “Plant Name Query Results for Momordica”. IPNI. http://www.ipni.org:80/ipni/advPlantNameSearch do?find_family=&find_genus=Momordica&find_species=&find_infrafamily=&find_infragenus=&find_infraspecies=&find_authorAbbrev=&find_includePublicationAuthors=on&find_includePublicationAuthors=off&find_includeBasionymAuthors=on&find_includeBasionymAuthors=off&find_publicationTitle=&find_is APNIRecord=on&find_isAPNIRecord=false&find_isGCIRecord=on&find_isGCIRecord=false&find_isIKRecord=on&find_isIKRecord=false&find_rankToReturn=spec&output_format=normal&find_sortByFamily=on&find_sortByFamily=off&query_type=by_query&back_page=plantsearch. Retrieved Oct. 22, 2009.

What is claimed is:

1. A process for the preparation of wine from various combinations of above ground plant parts such as fruits, stems, leaves, tendrils, and flowers from plants belonging to the genus Momordica in the family Cucurbitaceae, in the Kingdom Plantae, steps of: (a) selecting fresh, disease-free above-ground plant parts from various Momordica plant species and cultivars (above-ground plant parts referred to are fruits, stems, flowers, tendrils and leaves, singly or in various combinations); cleaning and surface sterilization of harvested Momordica plant parts; (b) dipping into acidic solution or spraying with acidic solution; (c) crushing, macerating, slicing, grinding, juicing, comminuting of Momordica plant parts and collecting into sterilized primary fermenter; (d) combining with pectic enzyme, amylase, acids, warm water, and optional addition of sulfites into the same sterilized primary fermenter; (e) maintaining optimum temperature and allowing the mixture to stand for 0.25-72 hours; (f) adding sugars to the mixture; (g) adding yeast or yeast culture and yeast nutrient to the mixture; (h) aeration and stirring to add oxygen, cooling and submerging the Momordica plant parts for better extraction; (i) straining of the wine and collecting into sterilized secondary fermenter for anaerobic fermentation when the specific gravity reading dips below 1.025; (j) racking off sediments of the wine into a sterile container and optional addition of cinnamon to stop the yeast from fermentation, stabilize and preserve the wine; (k) racking off the cinnamon sediments into sterilized containers, optional addition of fining agents; (l) conditioning the wine with sweeteners, food-grade glycerine and other optional spices; aging the wine; (m) optional filtering, bottling and further storage or aging of the wine;

2. The process according to claim 1, wherein in step (a), the Momordica plant parts to be used is 0.10 Kg to about 2.05 Kg fresh weight per 750 bottle of final wine.

3. The process according to claim 1, wherein in step (c), the acidic solution used is composed of ascorbic acid, citric acid, malic acid, tartaric acid and juices from tart types of citruses.

4. The process according to claim 3, wherein the tart types of citruses are from lemons, limes, calamondins, limequats, lemonquats, yuzu, yuzuquat, and sudachi hybrid.

5. The process according to claim 1, wherein in step (d) the acidic solution is added such that the total acidity of the must shall be in the range of 0.15% to 0.95% titrable acidity and a pH range of 2.00 to 5.00.

6. The process according to claim 1, wherein in step (d), warm water added is added at a rate of between 0.10 liter to 8.0 liters per kg of Momordica plant parts.

7. The process according to claim 1, wherein in step (d), pectic enzymes are added at a rate of 0.10 to 10 grams per liter mixture.

8. The process according to claim 1, wherein in step (d), amylase or amyloglucosidase enzymes are added at a rate of 0.05 to 5 grams per liter mixture.

9. The process according to claim 1, wherein in step (d), optional sulfites are added at the rate of 1 mg to 400 mg per liter mixture.

10. The process according to claim 1, wherein in step (e), the temperature range is between 27 to 52 deg C. with optimum at 45 deg C.

11. The process according to claim 1, wherein in step (f), the added sugars are fermentable sugars.

12. The process according to claim 11, wherein added sugars are added at a rate of about 0.10 kg to 1.09 kg per liter of mixture.

13. The process according to claim 1, wherein in step (g), the preferred yeast added is from the previous batch of primary fermentation.

14. The process according to claim 1, wherein in step (i), straining of the mixture and transferring into secondary fermenter is done when the specific gravity of the mixture falls below 1.025.

15. The process according to claim 1, wherein in step (j), the optional wine stabilizer is composed of sulfites and potassium sorbate.

16. The process according to claim 1, wherein in step (j), the cinnamon is in the form of cinnamon sticks.

17. The process according to claim 16, wherein the cinnamon sticks is added at the rate of about 0.05 gram to 100 grams per liter of wine.

18. The process according to claim 1, wherein in step (j), the cinnamon is in the form of cinnamon powder.

19. The process according to claim 18, wherein the total cinnamon powder used is about 0.05 gram to 50 grams per liter of wine.

20. The process according to claim 1, wherein in step (1), the optional sweetener is Stevia.

21. The process according to claim 1, wherein in step (k), fining agents are used if the wine is cloudy.

21. The process according to claim 1, wherein in step (1), the optional sweetener is Aspartame.

22. The process according to claim 1, wherein in step (1), the optional sweetener is maple syrup, honey, table sugars brown sugar, or inverted sugar.

23. The process according to claim 21, wherein the amount of sweeteners added should result in the total sugars in the final wine to range from 0% to 5% by weight.

24. Wine is produced by the process according to claim 1.

25. The process according to claim 1, wherein the Momordica plant parts is from Momordica genus.
